(19) United States
(12) Patent Application Publication
(10) Pub. No.: US 2005/0215148 A1
(43) Pub. Date: Sep. 29, 2005

(54) Pre-impregnated materials

(75) Inventor: Eran Werner, Kfar Vradim (IL)

Correspondence Address: Ladas & Parry, 26 West 61 Street, New York, NY, 10023, US

(73) Assignee: PC COMPOSITES LTD.

(21) Appl. No.: 10/809,284

(22) Filed: Mar. 25, 2004

(51) Int. Cl. B32B 5/02; B32B 27/04; B32B 27/12

(52) U.S. Cl. 442/62; 442/64; 442/66; 442/68; 442/70; 442/71; 442/72; 442/74

(57) ABSTRACT

A pre-impregnated material including a textile substrate and resin adhered to the textile substrate, the pre-impregnated material being characterized in that the resin has a uniformity of thickness having a variation of less than 5% of its average thickness. Pre-impregnated materials with other properties are also disclosed.

### FIELD OF THE INVENTION

The present invention relates to pre-impregnated materials generally.

### BACKGROUND OF THE INVENTION

The following U.S. Patent Documents are believed to represent the current state of the art: U.S. Pat. Nos. 6,656,316; 6,620,243; 5,911,932; 5,895,622; 5,820,941; 5;800,615; 5,639,307; 5,409,757; 5,360,661; 5,310,582; 5,302,419; 5,296,064; 5,198,281; 5,171,630; 5,094,883 and 4,634,058.

### SUMMARY OF THE INVENTION

The present invention seeks to provide improved pre-impregnated materials.

There is thus provided in accordance with a preferred embodiment of the present invention a pre-impregnated material including a textile substrate and resin adhered to the textile substrate, the pre-impregnated material being characterized in that the resin has a uniformity of thickness having a variation of less than 5% of its average thickness.

There is also provided in accordance with another preferred embodiment of the present invention a pre-impregnated material including a textile substrate and resin adhered to the textile substrate, the pre-impregnated material being characterized in that the resin has an impregnation depth of at least 60% of the thickness of the textile substrate.

There is further provided in accordance with still another preferred embodiment of the present invention a pre-impregnated material including a textile substrate and resin adhered to the textile substrate, the pre-impregnated material being characterized in that the resin has a thickness exceeding 300 microns.

There is yet further provided in accordance with another preferred embodiment of the present invention a pre-impregnated material including a textile substrate and resin adhered to the textile substrate, the pre-impregnated material being characterized in that the weight of the resin is at least 70% of the weight of the pre-impregnated material.

There is even further provided in accordance with yet another preferred embodiment of the present invention a pre-impregnated material including a textile substrate and resin adhered to the textile substrate, the pre-impregnated material being characterized in that the resin has a thickness less than 50 microns.

There is still further provided in accordance with still another preferred embodiment of the present invention a pre-impregnated material including a textile substrate and resin adhered to the textile substrate, the pre-impregnated material being characterized in that the weight of the resin is less than 10% of the weight of the pre-impregnated material.

There is also provided in accordance with another preferred embodiment of the present invention a pre-impregnated material including a textile substrate and resin adhered to the textile substrate, the pre-impregnated material being characterized in that the resin includes particles having a size spectrum which extends over at least two orders of magnitude.

There is further provided in accordance with yet another preferred embodiment of the present invention a pre-impregnated material including a textile substrate and resin adhered to the textile substrate, the pre-impregnated material being characterized in that the resin includes particles having a density spectrum which extends over at least one order of magnitude.

In accordance with another preferred embodiment of the present invention the resin has a uniformity of thickness having a variation of less than 5% of its average thickness. In accordance with another preferred embodiment of the present invention the resin has a uniformity of thickness having a variation of less than 2% of its average thickness. In accordance with yet another preferred embodiment of the present invention the resin has a uniformity of thickness having a variation of less than 2% of its average thickness along its width.

In accordance with another preferred embodiment of the present invention the resin has an impregnation depth of at least 60% of the thickness of the textile substrate. In accordance with yet another preferred embodiment of the present invention the resin has an impregnation depth of at least 80% of the thickness of the textile substrate.

In accordance with another preferred embodiment of the present invention the weight of the resin is less than 5% of the weight of the pre-impregnated material.

In accordance with another preferred embodiment of the present invention the resin is fully melted. In accordance with yet another preferred embodiment of the present invention the resin is partially melted and partially in particulate form. In accordance with still another preferred embodiment of the present invention the resin is formed as a plurality of resin layers. In accordance with another preferred embodiment of the present invention the resin is formed as a plurality of resin layers having different thicknesses. In accordance with yet another preferred embodiment of the present invention the resin is formed as a plurality of resin layers formed of different resin materials.

There is also provided in accordance with another preferred embodiment of the present invention a laminate formed of a plurality of layers of pre-impregnated material, at least one of the plurality of layers of pre-impregnated material including a textile substrate and resin adhered to the textile substrate, the pre-impregnated material being characterized in that the resin has a uniformity of thickness having a variation of less than 5% of its average thickness.

There is further provided in accordance with yet another preferred embodiment of the present invention a laminate formed of a plurality of layers of pre-impregnated material, at least one of the plurality of layers of pre-impregnated material including a textile substrate and resin adhered to the textile substrate, the pre-impregnated material being characterized in that the resin has a thickness exceeding 300 microns.

There is even further provided in accordance with still another preferred embodiment of the present invention a laminate formed of a plurality of layers of pre-impregnated material, at least one of the plurality of layers of pre-impregnated material including a textile substrate and resin adhered to the textile substrate, the pre-impregnated material being characterized in that the weight of the resin is at least 70% of the weight of the pre-impregnated material.

There is yet further provided in accordance with another preferred embodiment of the present invention a laminate formed of a plurality of layers of pre-impregnated material, at least one of the plurality of layers of pre-impregnated material including a textile substrate and resin adhered to the textile substrate, the pre-impregnated material being characterized in that the resin has a thickness less than 50 microns.

There is still further provided in accordance with yet another preferred embodiment of the present invention a laminate formed of a plurality of layers of pre-impregnated material, at least one of the plurality of layers of pre-impregnated material including a textile substrate and resin adhered to the textile substrate, the pre-impregnated material being characterized in that the weight of the resin is less than 10% of the weight of the pre-impregnated material.

There is also provided in accordance with still another preferred embodiment of the present invention a laminate formed of a plurality of layers of pre-impregnated material, at least one of the plurality of layers of pre-impregnated material including a textile substrate and resin adhered to the textile substrate, the pre-impregnated material being characterized in that the resin includes particles having a size spectrum which extends over at least two orders of magnitude.

There is further provided in accordance with another preferred embodiment of the present invention a laminate formed of a plurality of layers of pre-impregnated material, at least one of the plurality of layers of pre-impregnated material including a textile substrate and resin adhered to the textile substrate, the pre-impregnated material being characterized in that the resin includes particles having a density spectrum which extends over at least one order of magnitude.

### BRIEF DESCRIPTION OF THE DRAWINGS

The present invention will be appreciated more fully from the following detailed description, taken in conjunction with the drawings in which:

FIG. 1 is a simplified sectional illustration of a pre-impregnated material constructed and operative in accordance with a preferred embodiment of the present invention, showing uniformity of resin thickness;

FIG. 2 is a simplified sectional illustration of a pre-impregnated material constructed and operative in accordance with another preferred embodiment of the present invention, showing uniformity of resin thickness;

FIG. 3 is a simplified sectional illustration of a pre-impregnated material constructed and operative in accordance with a preferred embodiment of the present invention, showing impregnation depth;

FIG. 4 is a simplified sectional illustration of a pre-impregnated material constructed and operative in accordance with a preferred embodiment of the present invention, showing high resin thickness;

FIG. 5 is a simplified sectional illustration of a pre-impregnated material constructed and operative in accordance with a preferred embodiment of the present invention, showing low resin thickness;

FIG. 6 is a simplified sectional illustration of a pre-impregnated material constructed and operative in accordance with another preferred embodiment of the present invention, showing uniformity of resin thickness;

FIG. 7 is a simplified sectional illustration of a pre-impregnated material constructed and operative in accordance with another preferred embodiment of the present invention, showing uniformity of resin thickness;

FIG. 8 is a simplified sectional illustration of a pre-impregnated material constructed and operative in accordance with a preferred embodiment of the present invention, showing impregnation depth;

FIG. 9 is a simplified sectional illustration of a pre-impregnated material constructed and operative in accordance with a preferred embodiment of the present invention, showing high resin thickness;

FIG. 10 is a simplified sectional illustration of a pre-impregnated material constructed and operative in accordance with a preferred embodiment of the present invention, showing low resin thickness;

FIG. 11 is a simplified sectional illustration of a laminate formed of a plurality of layers of pre-impregnated material constructed and operative in accordance with a preferred embodiment of the present invention; and

FIG. 12 is a simplified sectional illustration of a laminate formed of a plurality of layers of pre-impregnated material constructed and operative in accordance with a preferred embodiment of the present invention.

### DETAILED DESCRIPTION OF PREFERRED EMBODIMENTS

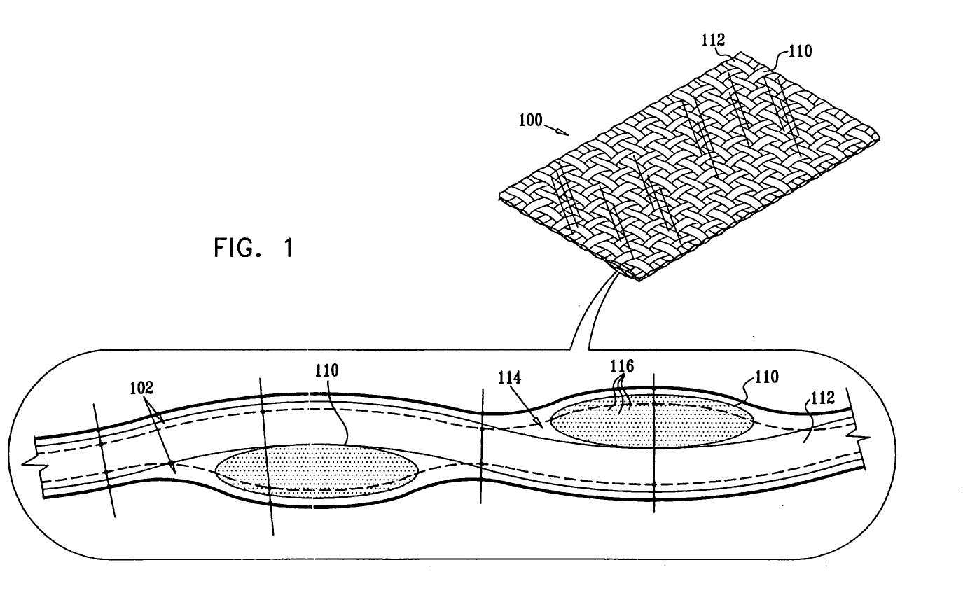

Reference is now made to FIG. 1, which is a simplified sectional illustration of a pre-impregnated material constructed and operative in accordance with a preferred embodiment of the present invention, showing uniformity of resin thickness. As seen in FIG. 1, a fabric 100 is shown impregnated with a resin forming at least one resin layer 102 having a high degree of uniformity of thickness, having a variation of less than 5% and preferably approximately 1%. The illustrated embodiment includes two layers 102, on opposite surfaces of the fabric 100, each layer preferably of thickness about 100 microns.

The fabric 100 may be any suitable type of fabric, woven as shown in FIG. 1 or alternatively non-woven or formed in any other suitable manner. The term “fabric” as used throughout the specification and claims, includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

It is seen that in the illustrated example, warp fibers 110 and weft fibers 112 and the interstices 114 therebetween each have formed thereon and therein a pair of opposite-facing resin layers 102 whose thickness is uniform to a high degree, having a variation of less than 5% and preferably approximately 1%. Typically each of warp fibers 110 and weft fibers 112 is formed of a multiplicity of individual fiber strands 116.

The pre-impregnated material of FIG. 1 is preferably realized by accelerated impingement of a stream of resin particles onto the fabric 100 followed by the application of heat, in accordance with the teachings of applicant/assignee's Published PCT Patent Application WO 03/024609, the disclosure of which is hereby incorporated by reference.

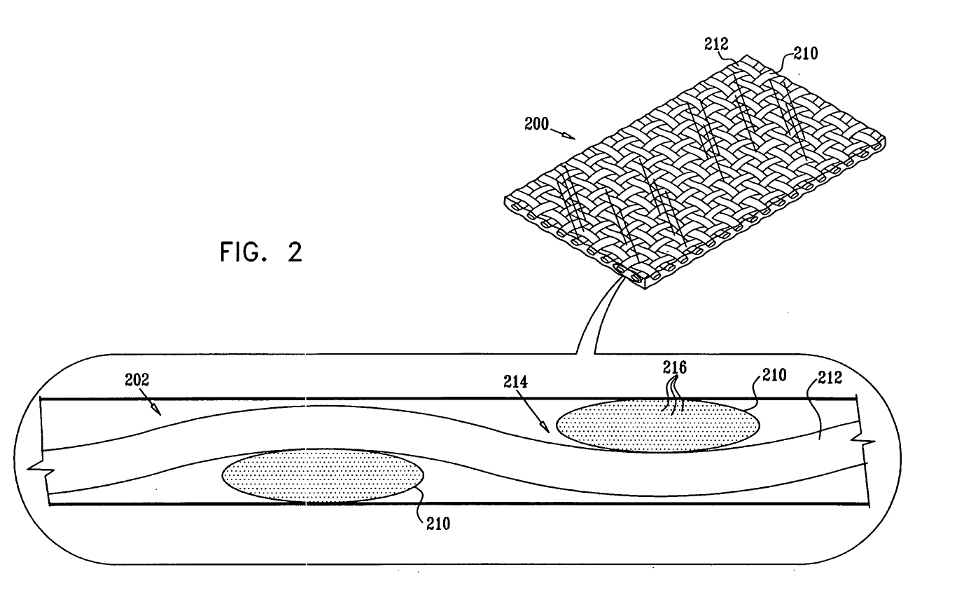

Reference is now made to FIG. 2, which is a simplified sectional illustration of a pre-impregnated material constructed and operative in accordance with another preferred embodiment of the present invention, showing uniformity of resin thickness. The essential difference between the embodiment of FIG. 2 and that of FIG. 1, described hereinabove, is in the amount of resin impregnated into the fabric.

As seen in FIG. 2, a fabric 200 is shown fully impregnated with a resin and forming a fully impregnated fabric layer 202 having a high degree of uniformity of thickness, having a variation of less than 5% and preferably approximately 1%. The thickness is preferably about 500 microns.

The fabric 200 may be any suitable type of fabric, woven as shown in FIG. 2 or alternatively non-woven or formed in any other suitable manner. The term “fabric” includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

Turning to FIG. 2, it is seen that in the illustrated example, warp fibers 210 and weft fibers 212 and the interstices 214 therebetween each are fully impregnated such that layer 202 has thickness which is uniform to a high degree, having a variation of less than 5% and preferably approximately 1%. Typically each of warp fibers 210 and weft fibers 212 is formed of a multiplicity of individual fiber strands 216.

It is appreciated that the embodiment of FIG. 2 is typically more rigid than the embodiment of FIG. 1.

The pre-impregnated material of FIG. 2 is preferably realized by accelerated impingement of a stream of resin particles onto the fabric 200 followed by the application of heat, in accordance with the teachings of applicant/assignee's Published PCT Patent Application WO 03/024609, the disclosure of which is hereby incorporated by reference.

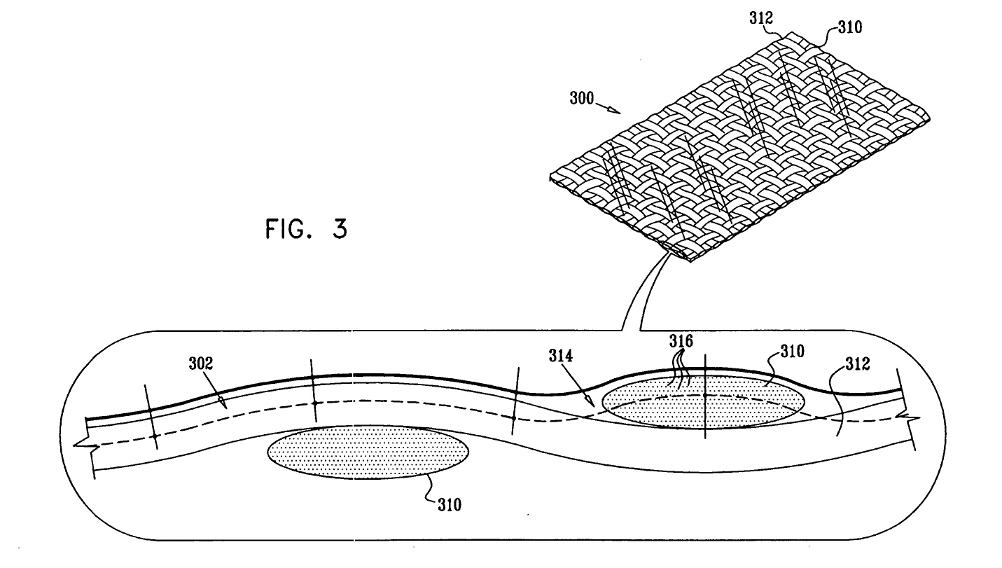

Reference is now made to FIG. 3, which is a simplified sectional illustration of a pre-impregnated material constructed and operative in accordance with another preferred embodiment of the present invention. The difference between the embodiment of FIG. 3 and that of FIG. 1, described hereinabove, is in the fact that the fabric is coated only on one side thereof.

As seen in FIG. 3, similarly to that described hereinabove with reference to FIG. 1, a fabric 300 is shown impregnated with a resin forming a resin layer 302 having a high degree of uniformity of thickness, having a variation of less than 5% and preferably approximately 1%. The illustrated embodiment includes a single layer 302, typically of thickness approximately 200 microns.

The fabric 300 may be any suitable type of fabric, woven as shown in FIG. 3 or alternatively non-woven or formed in any other suitable manner. The term “fabric” as used throughout the specification and claims, includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

It is seen that in the illustrated example, warp fibers 310 and weft fibers 312 and the interstices 314 therebetween each have formed thereon and therein a resin layer 302 whose thickness is uniform to a high degree, having a variation of less than 5% and preferably approximately 1%. Typically each of warp fibers 310 and weft fibers 312 is formed of a multiplicity of individual fiber strands 316.

The pre-impregnated material of FIG. 3 is preferably realized by accelerated impingement of a stream of resin particles onto the fabric 300 followed by the application of heat, in accordance with the teachings of applicant/assignee's Published PCT Patent Application WO 03/024609, the disclosure of which is hereby incorporated by reference.

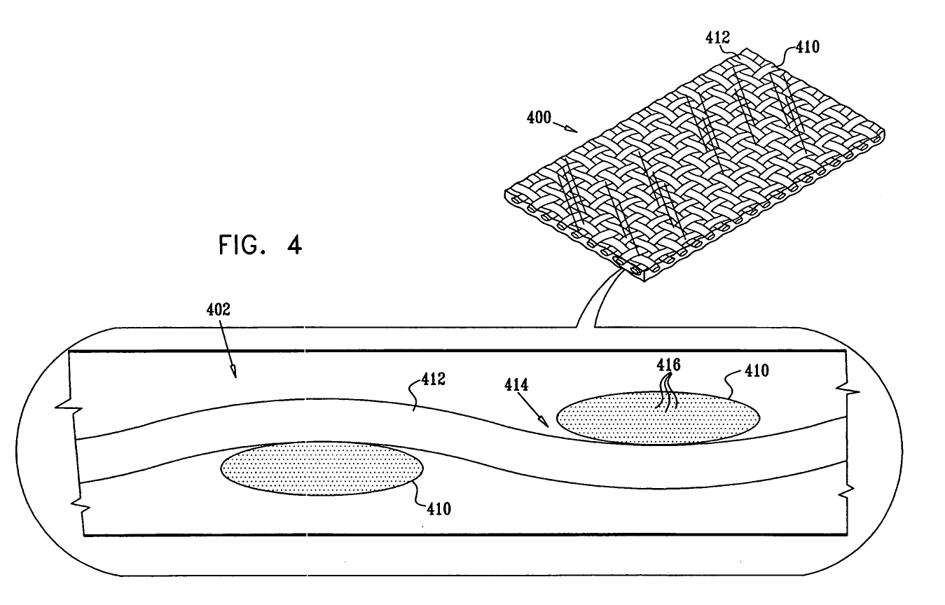

Reference is now made to FIG. 4, which is a simplified sectional illustration of a pre-impregnated material constructed and operative in accordance with a preferred embodiment of the present invention, showing high resin thickness. The essential difference between FIG. 4 and FIG. 2 described hereinabove lies in the overall resin thickness.

As seen in FIG. 4, a fabric 400 is shown fully impregnated with a resin and forming a fully impregnated fabric layer 402 having a high degree of uniformity of thickness, having a variation of less than 5% and preferably approximately 1%. The thickness is preferably above 500 microns and may reach up to approximately 6 mm.

The fabric 400 may be any suitable type of fabric, woven as shown in FIG. 4 or alternatively non-woven or formed in any other suitable manner. The term “fabric” includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

Turning to FIG. 4, it is seen that in the illustrated example, warp fibers 410 and weft fibers 412 and the interstices 414 therebetween each are fully impregnated and additional resin is formed thereover, preferably on both surfaces of the fabric, such that layer 402 has thickness which is uniform to a high degree, having a variation of less than 5% and preferably approximately 1%. Typically each of warp fibers 410 and weft fibers 412 is formed of a multiplicity of individual fiber strands 416.

The pre-impregnated material of FIG. 4 is preferably realized by accelerated impingement of a stream of resin particles onto the fabric 400 followed by the application of heat, in accordance with the teachings of applicant/assignee's Published PCT Patent Application WO 03/024609, the disclosure of which is hereby incorporated by reference.

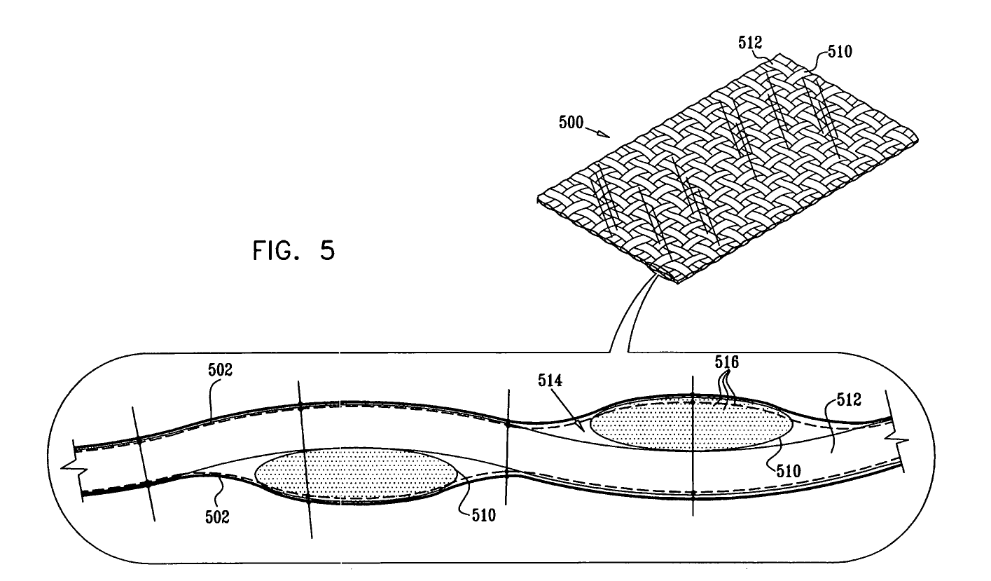

Reference is now made to FIG. 5, which is a simplified sectional illustration of a pre-impregnated material constructed and operative in accordance with a preferred embodiment of the present invention, showing a relatively low resin thickness. The essential difference between the embodiment of FIG. 5 and that of FIG. 1, described hereinabove, is in the amount of resin impregnated into the fabric. In the embodiment of FIG. 5, a relatively small amount of resin is impregnated into the fabric, producing relatively thin, but highly uniform, layers of resin.

As seen in FIG. 5, a fabric 500 is shown impregnated with a resin forming at least one resin layer 502 having a high degree of uniformity of thickness, having a variation of less than 5% and preferably approximately 1%. The illustrated embodiment includes two layers 502, on opposite surfaces of the fabric 500, each layer preferably of thickness about 30 microns.

The fabric 500 may be any suitable type of fabric, woven as shown in FIG. 5 or alternatively non-woven or formed in any other suitable manner. The term “fabric” as used throughout the specification and claims, includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

It is seen that in the illustrated example, warp fibers 510 and weft fibers 512 and the interstices 514 therebetween each have formed thereon and therein a pair of opposite-facing resin layers 502 whose thickness is uniform to a high degree, having a variation of less than 5% and preferably approximately 1%. Typically each of warp fibers 510 and weft fibers 512 is formed of a multiplicity of individual fiber strands 516.

The pre-impregnated material of FIG. 5 is preferably realized by accelerated impingement of a stream of resin particles onto the fabric 500 followed by the application of heat, in accordance with the teachings of applicant/assignee's Published PCT Patent Application WO 03/024609, the disclosure of which is hereby incorporated by reference.

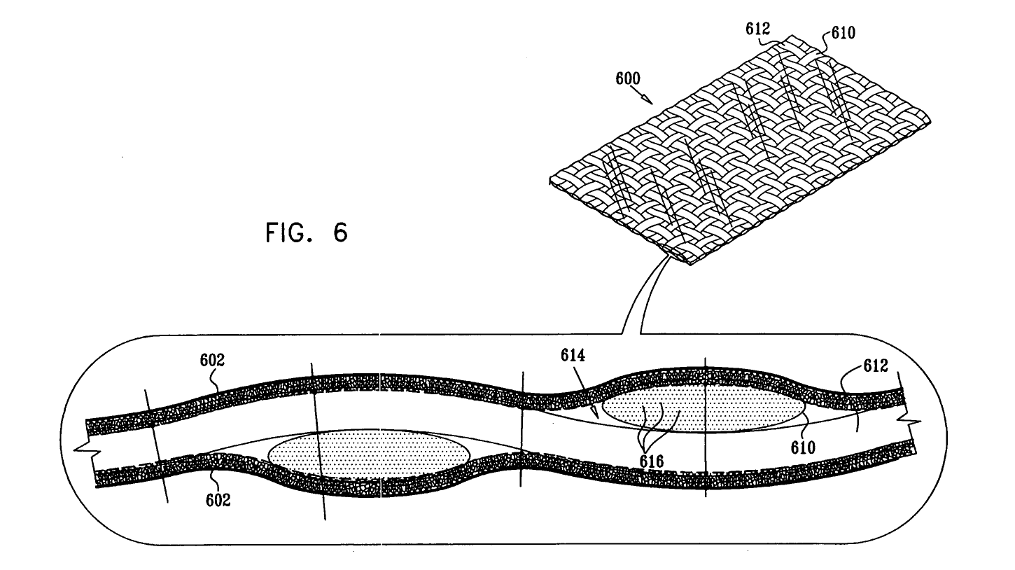

Reference is now made to FIG. 6-10, which are similar to FIGS. 1-5, but differ therefrom in that a lesser amount of heat has been applied to the resin following impregnation of the fabric, thereby producing a partially-particulate, partially melted resin matrix, as distinguished from a fully melted resin matrix in the embodiments of FIGS. 1-5. In the embodiments of FIGS. 6-10, the resin layers lie outside of the fabric to a somewhat greater degree than in the embodiments of FIGS. 1-5.

Reference is now made to FIG. 6, which is a simplified sectional illustration of a pre-impregnated material constructed and operative in accordance with a preferred embodiment of the present invention, showing uniformity of resin thickness. As seen in FIG. 6, a fabric 600 is shown impregnated with a resin forming at least one resin layer 602 having a high degree of uniformity of thickness, having a variation of less than 5% and preferably approximately 1%. The illustrated embodiment includes two layers 602, on opposite surfaces of the fabric 600, each layer preferably of thickness about 100 microns.

The fabric 600 may be any suitable type of fabric, woven as shown in FIG. 6 or alternatively non-woven or formed in any other suitable manner. The term “fabric” as used throughout the specification and claims, includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

It is seen that in the illustrated example, warp fibers 610 and weft fibers 612 and the interstices 614 therebetween each have formed thereon and therein a pair of opposite-facing resin layers 602 whose thickness is uniform to a high degree, having a variation of less than 5% and preferably approximately 1%. Typically each of warp fibers 610 and weft fibers 612 is formed of a multiplicity of individual fiber strands 616.

The pre-impregnated material of FIG. 6 is preferably realized by accelerated impingement of a stream of resin particles onto the fabric 600 followed by the application of heat, in accordance with the teachings of applicant/assignee's Published PCT Patent Application WO 03/024609, the disclosure of which is hereby incorporated by reference.

As noted above, in the embodiments of FIGS. 6-10, the resin layers lie outside of the fabric to a somewhat greater degree than in the embodiments of FIGS. 1-5. In the above-described embodiment of FIG. 6, it is seen that approximately 60% of the thickness of each of the resin layers 602 lies outside of the fabric, while in FIG. 1 approximately 40% of the resin layers 102 lies outside the fabric.

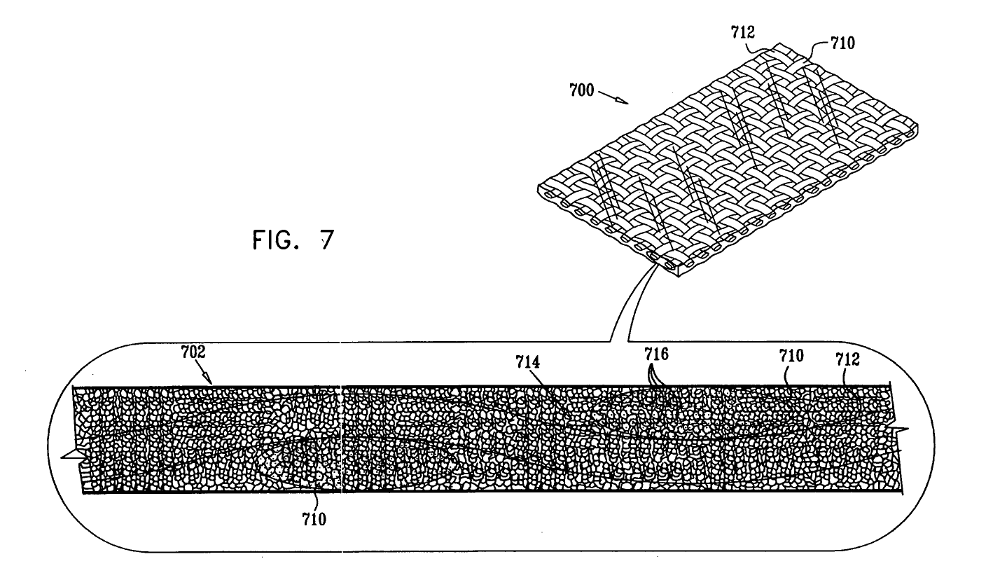

Reference is now made to FIG. 7, which is a simplified sectional illustration of a pre-impregnated material constructed and operative in accordance with another preferred embodiment of the present invention, showing uniformity of resin thickness. The essential difference between the embodiment of FIG. 7 and that of FIG. 6, described hereinabove, is in the amount of resin impregnated into the fabric.

As seen in FIG. 7, a fabric 700 is shown fully impregnated with a resin and forming a fully impregnated fabric layer 702 having a high degree of uniformity of thickness, having a variation of less than 5% and preferably approximately 1%. The thickness is preferably about 500 microns.

The fabric 700 may be any suitable type of fabric, woven as shown in FIG. 7 or alternatively non-woven or formed in any other suitable manner. The term “fabric” includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

Turning to FIG. 7, it is seen that in the illustrated example, warp fibers 710 and weft fibers 712 and the interstices 714 therebetween each are fully impregnated such that layer 702 has thickness which is uniform to a high degree, having a variation of less than 5% and preferably approximately 1%. Typically each of warp fibers 710 and weft fibers 712 is formed of a multiplicity of individual fiber strands 716.

It is appreciated that the embodiment of FIG. 7 is typically more rigid than the embodiment of FIG. 6.

The pre-impregnated material of FIG. 7 is preferably realized by accelerated impingement of a stream of resin particles onto the fabric 700 followed by the application of heat, in accordance with the teachings of applicant/assignee's Published PCT Patent Application WO 03/024609, the disclosure of which is hereby incorporated by reference.

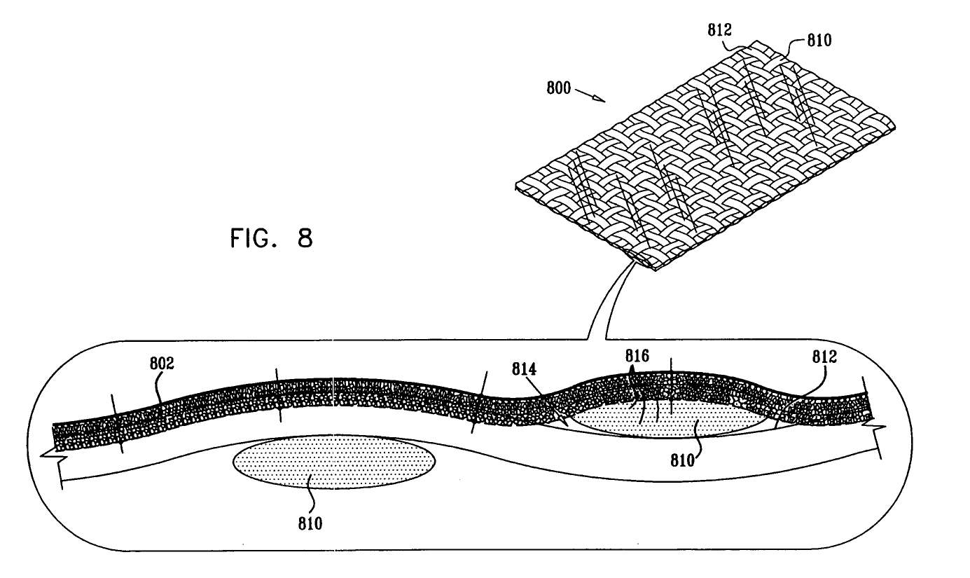

Reference is now made to FIG. 8, which is a simplified sectional illustration of a pre-impregnated material constructed and operative in accordance with another preferred embodiment of the present invention. The difference between the embodiment of FIG. 8 and that of FIG. 6, described hereinabove, is in the fact that the fabric is coated only on one side thereof.

As seen in FIG. 8, similarly to that described hereinabove with reference to FIG. 6, a fabric 800 is shown impregnated with a resin forming a resin layer 802 having a high degree of uniformity of thickness, having a variation of less than 5% and preferably approximately 1%. The illustrated embodiment includes a single layer 802, typically of thickness approximately 200 microns.

The fabric 800 may be any suitable type of fabric, woven as shown in FIG. 8 or alternatively non-woven or formed in any other suitable manner. The term “fabric” as used throughout the specification and claims, includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

It is seen that in the illustrated example, warp fibers 810 and weft fibers 812 and the interstices 814 therebetween each have formed thereon and therein a resin layer 802 whose thickness is uniform to a high degree, having a variation of less than 5% and preferably approximately 1%. Typically each of warp fibers 810 and weft fibers 812 is formed of a multiplicity of individual fiber strands 816.

The pre-impregnated material of FIG. 8 is preferably realized by accelerated impingement of a stream of resin particles onto the fabric 800 followed by the application of heat, in accordance with the teachings of applicant/assignee's Published PCT Patent Application WO 03/024609, the disclosure of which is hereby incorporated by reference.

As noted above, in the embodiments of FIGS. 6-10, the resin layers lie outside of the fabric to a somewhat greater degree than in the embodiments of FIGS. 1-5. In the above-described embodiment of FIG. 8, it is seen that approximately 60% of the thickness of each of the resin layers 802 lies outside of the fabric, while in FIG. 3 approximately 40% of the resin layers 102 lies outside the fabric.

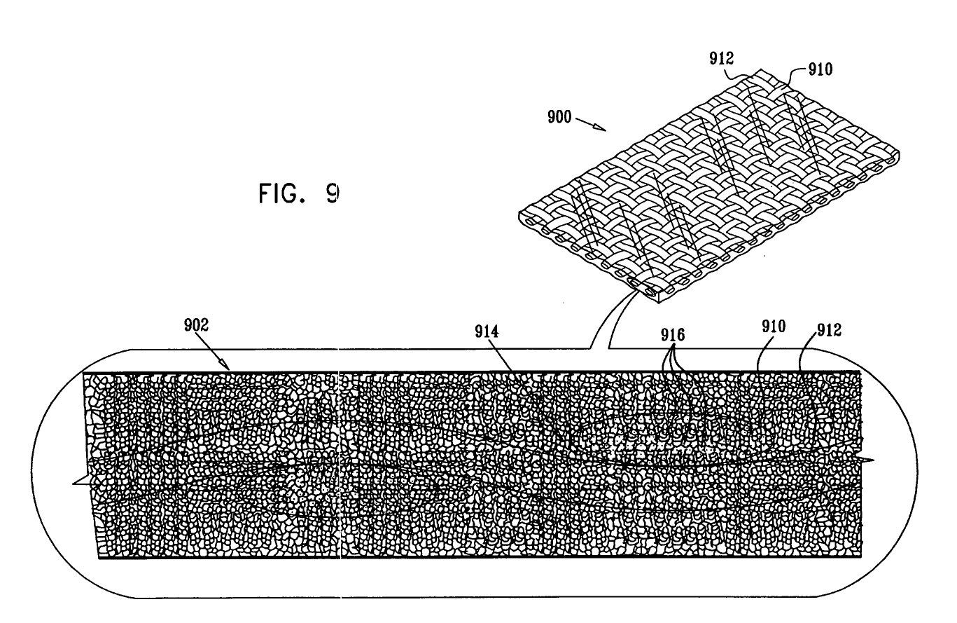

Reference is now made to FIG. 9, which is a simplified sectional illustration of a pre-impregnated material constructed and operative in accordance with a preferred embodiment of the present invention, showing high resin thickness. The essential difference between FIG. 9 and FIG. 7 described hereinabove lies in the overall resin thickness.

As seen in FIG. 9, a fabric 900 is shown fully impregnated with a resin and forming a fully impregnated fabric layer 902 having a high degree of uniformity of thickness, having a variation of less than 5% and preferably approximately 1%. The thickness is preferably above 500 microns and may reach up to approximately 6 mm.

The fabric 900 may be any suitable type of fabric, woven as shown in FIG. 9 or alternatively non-woven or formed in any other suitable manner. The term “fabric” includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

Turning to FIG. 9, it is seen that in the illustrated example, warp fibers 910 and weft fibers 912 and the interstices 914 therebetween each are fully impregnated and additional resin is formed thereover, preferably on both surfaces of the fabric, such that layer 902 has thickness which is uniform to a high degree, having a variation of less than 5% and preferably approximately 1%. Typically each of warp fibers 910 and weft fibers 912 is formed of a multiplicity of individual fiber strands 916.

The pre-impregnated material of FIG. 9 is preferably realized by accelerated impingement of a stream of resin particles onto the fabric 900 followed by the application of heat, in accordance with the teachings of applicant/assignee's Published PCT Patent Application WO 03/024609, the disclosure of which is hereby incorporated by reference.

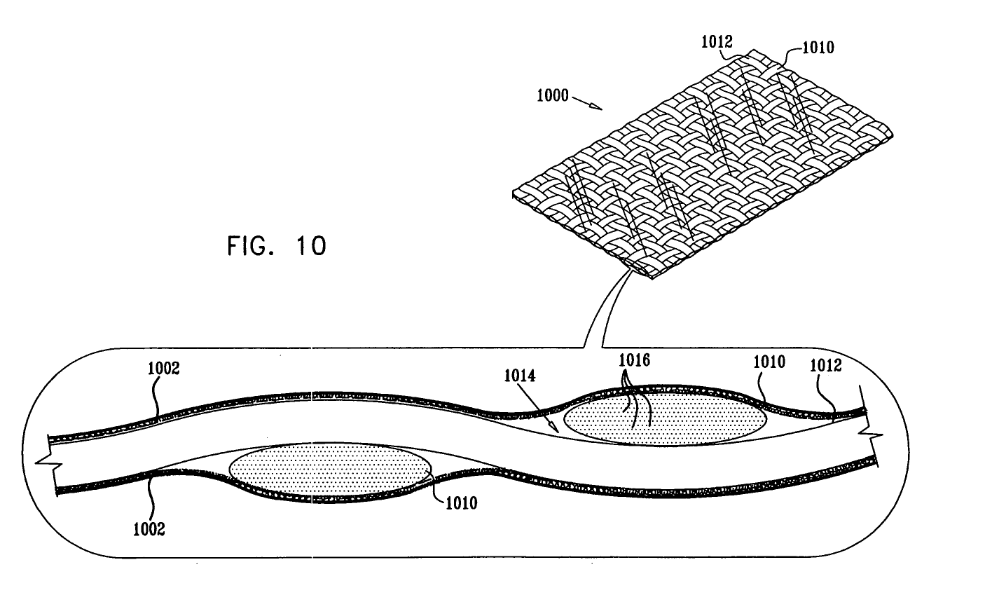

Reference is now made to FIG. 10, which is a simplified sectional illustration of a pre-impregnated material constructed and operative in accordance with a preferred embodiment of the present invention, showing a relatively low resin thickness. The essential difference between the embodiment of FIG. 10 and that of FIG. 5, described hereinabove, is in the amount of resin impregnated into the fabric. In the embodiment of FIG. 10, a relatively small amount of resin is impregnated into the fabric, producing relatively thin, but highly uniform layers of resin.

As seen in FIG. 10, a fabric 1000 is shown impregnated with a resin forming at least one resin layer 1002 having a high degree of uniformity of thickness, having a variation of less than 5% and preferably approximately 1%. The illustrated embodiment includes two layers 1002, on opposite surfaces of the fabric 1000, each layer preferably of thickness about 30 microns.

The fabric 1000 may be any suitable type of fabric, woven as shown in FIG. 10 or alternatively non-woven or formed in any other suitable manner. The term “fabric” as used throughout the specification and claims, includes also an array of fibers which may or may not be interengaged and which may or may not extend along parallel directions. The array of fibers may or may not be homogeneous and may or may not include fibers of different materials and/or configurations and/or sizes.

The resin may be any suitable type of impregnatable resin, including, inter alia, thermosetting and/or thermoplastic materials, such as PP, PA, PPS, PEEK, PEKK, PBT, PEI, PAI, Epoxies, Phenolics and Polyimides. The resins may include both organic and non-organic materials. Preferably, the resins are impregnated in the form of powders having a particle size of between 1 and 200 microns.

It is seen that in the illustrated example, warp fibers 1010 and weft fibers 1012 and the interstices 1014 therebetween each have formed thereon and therein a pair of opposite-facing resin layers 1002 whose thickness is uniform to a high degree, having a variation of less than 5% and preferably approximately 1%. Typically each of warp fibers 1010 and weft fibers 1012 is formed of a multiplicity of individual fiber strands 1016.

The pre-impregnated material of FIG. 10 is preferably realized by accelerated impingement of a stream of resin particles onto the fabric 1000 followed by the application of heat, in accordance with the teachings of applicant/assignee's Published PCT Patent Application WO 03/024609, the disclosure of which is hereby incorporated by reference.

As noted above, in the embodiments of FIGS. 6-10, the resin layers lie outside of the fabric to a somewhat greater degree than in the embodiments of FIGS. 1-5. In the above-described embodiment of FIG. 10, it is seen that approximately 60% of the thickness of each of the resin layers 1002 lies outside of the fabric, while in FIG. 5, approximately 40% of the resin layers 502 lies outside the fabric.

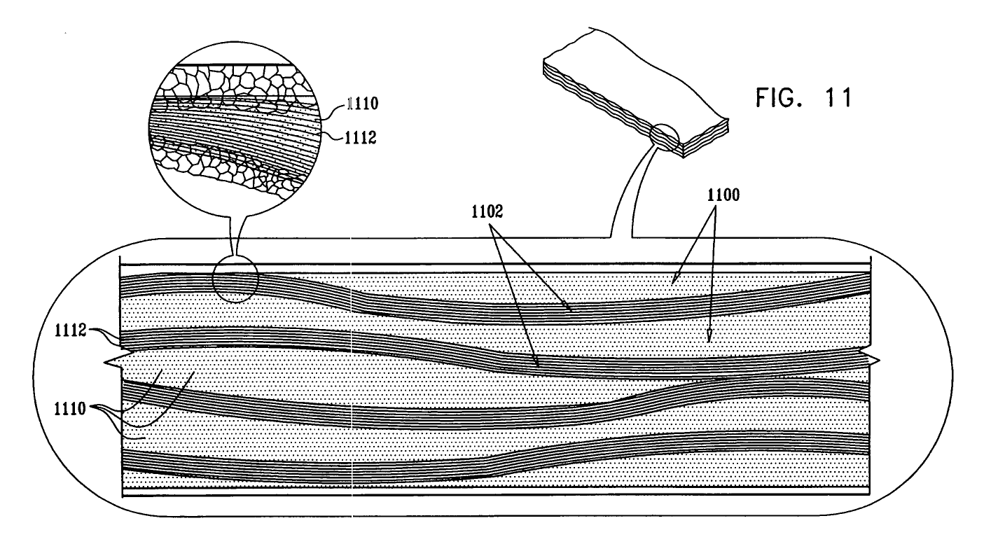

Reference is now made to FIG. 11, which illustrates a laminate formed of a plurality of layers of pre-impregnated material, preferably of the type described above with respect to any of FIGS. 1, 5, 6 and 10. This laminate is preferably formed by applying heat and pressure to a plurality of layers of the pre-impregnated material in a mold. As seen in FIG. 11, the application of pressure deforms the warp and weft fibers, here designated by reference numerals 1100 and 1102 respectively, spreading out the individual fiber strands thereof, respectively designated by reference numerals 1110 and 1112. In such a case, the resin layers of the various layers of pre-impregnated material become fused together, and the fibers of various layers of pre-impregnated material also tend to be merged. It is a particular feature of the present invention that due to the high degree of uniformity of thickness of the resin layers, voids in the laminate are avoided to a significant extent and highly uniform laminate surfaces are realized. The laminate of FIG. 11 is particularly suitable for use in resin transfer molding (RTM) in which additional resin is added during the final molding process.

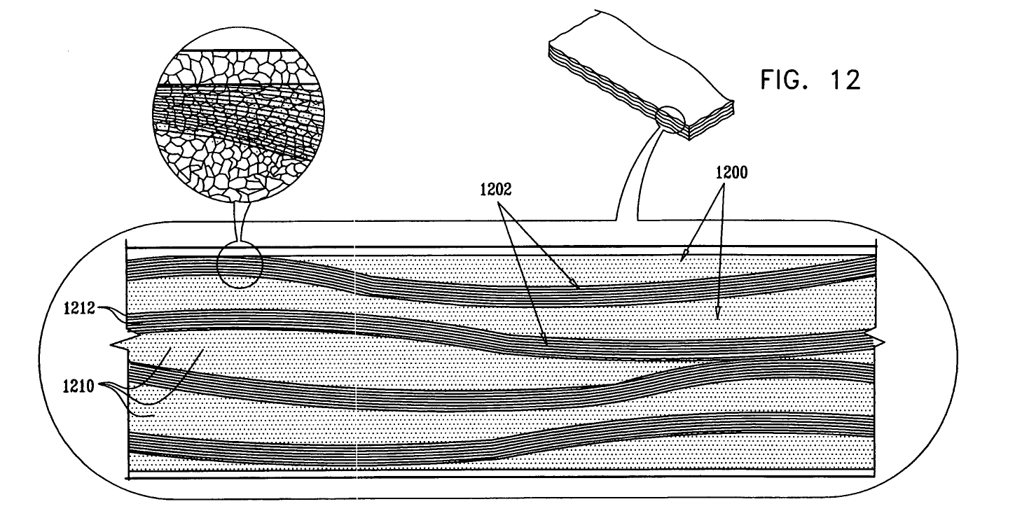

Reference is now made to FIG. 12, which illustrates a laminate formed of a plurality of layers of pre-impregnated material, preferably of the type described above with respect to any of FIGS. 2, 4, 7 and 9. This laminate is preferably formed by applying heat and pressure to a plurality of layers of the pre-impregnated material in a mold. As seen in FIG. 12, the application of pressure deforms the warp and weft fibers, here designated by reference numerals 1200 and 1202 respectively, spreading out the individual fiber strands thereof, respectively designated by reference numerals 1210 and 1212. In such a case, the resin layers of the various layers of pre-impregnated material become fused together, and the fibers of various layers of pre-impregnated material also tend to be merged. It is a particular feature of the present invention that due to the high degree of uniformity of thickness of the resin layers, voids in the laminate are avoided to a significant extent and highly uniform laminate surfaces are realized. The laminate of FIG. 12 is suitable for molding which does not involve the addition of resin to the laminate.

It will be appreciated by persons skilled in the art that the present invention is not limited by what has been particularly shown and described hereinabove. Rather the scope of the present invention includes both combinations and subcombinations of various features described and shown in the foregoing description as well as modifications and variations thereof which would occur to a person of ordinary skill in the art upon reading the foregoing description and which are not in the prior art.

1. A pre-impregnated material comprising:
a textile substrate; and
resin adhered to said textile substrate,
said pre-impregnated material being characterized in that said resin has a uniformity of thickness having a variation of less than 5% of its average thickness.

2. A pre-impregnated material according to claim 1 and wherein said resin has a uniformity of thickness having a variation of less than 2% of its average thickness.

3. A pre-impregnated material according to claim 1 and wherein said resin has a uniformity of thickness having a variation of less than 2% of its average thickness along its width.

4. A pre-impregnated material comprising:
a textile substrate; and
resin adhered to said textile substrate,
said pre-impregnated material being characterized in that said resin has an impregnation depth of at least 60% of the thickness of said textile substrate.

5. A pre-impregnated material according to claim 4 and wherein said resin has a uniformity of thickness having a variation of less than 5% of its average thickness.

6. A pre-impregnated material according to claim 4 and wherein said resin has a uniformity of thickness having a variation less than 2% of its average thickness.

7. A pre-impregnated material according to claim 4 and wherein said resin has a uniformity of thickness having a variation less than 2% of its average thickness along its width.

8. A pre-impregnated material according to claim 1 and wherein said resin has an impregnation depth of at least 80% of the thickness of said textile substrate.

9. A pre-impregnated material comprising:
a textile substrate; and
resin adhered to said textile substrate,
said pre-impregnated material being characterized in that said resin has a thickness exceeding 300 microns.

10. A pre-impregnated material according to claim 9 and wherein said resin has a uniformity of thickness having a variation of less than 2% of its average thickness.

11. A pre-impregnated material according to claim 9 and wherein said resin has a uniformity of thickness having a variation of less than 2% of its average thickness along its width.

12. A pre-impregnated material according to claim 9 and wherein said resin has an impregnation depth of at least 60% of the thickness of said textile substrate.

13. A pre-impregnated material according to claim 12 and wherein said resin has a uniformity of thickness having a variation of less than 5% of its average thickness.

14. A pre-impregnated material according to claim 12 and wherein said resin has a uniformity of thickness having a variation less than 2% of its average thickness.

15. A pre-impregnated material according to claim 9 and wherein said resin has an impregnation depth of at least 80% of the thickness of said textile substrate.

16. A pre-impregnated material comprising:
a textile substrate; and
resin adhered to said textile substrate,
said pre-impregnated material being characterized in that the weight of said resin is at least 70% of the weight of said pre-impregnated material.

17. A pre-impregnated material according to claim 16 and wherein said resin has a uniformity of thickness having a variation of less than 2% of its average thickness.

18. A pre-impregnated material according to claim 17 and wherein said resin has a uniformity of thickness having a variation of less than 2% of its average thickness along its width.

19. A pre-impregnated material according to claim 16 and wherein said resin has an impregnation depth of at least 60% of the thickness of said textile substrate.

20. A pre-impregnated material according to claim 19 and wherein said resin has a uniformity of thickness having a variation of less than 5% of its average thickness.

21. A pre-impregnated material according to claim 19 and wherein said resin has a uniformity of thickness having a variation less than 2% of its average thickness.

22. A pre-impregnated material according to claim 19 and wherein said resin has a uniformity of thickness having a variation less than 2% of its average thickness along its width.

23. A pre-impregnated material according to claim 16 and wherein said resin has an impregnation depth of at least 80% of the thickness of said textile substrate.

24. A pre-impregnated material comprising:
a textile substrate; and
resin adhered to said textile substrate,
said pre-impregnated material being characterized in that said resin has a thickness less than 50 microns.

25. A pre-impregnated material according to claim 24 and wherein said resin has a uniformity of thickness having a variation of less than 2% of its average thickness.

26. A pre-impregnated material according to claim 25 and wherein said resin has a uniformity of thickness having a variation of less than 2% of its average thickness along its width.

27. A pre-impregnated material according to claim 24 and wherein said resin has an impregnation depth of at least 60% of the thickness of said textile substrate.

28. A pre-impregnated material according to claim 27 and wherein said resin has a uniformity of thickness having a variation of less than 5% of its average thickness.

29. A pre-impregnated material according to claim 27 and wherein said resin has a uniformity of thickness having a variation less than 2% of its average thickness.

30. A pre-impregnated material according to claim 27 and wherein said resin has a uniformity of thickness having a variation less than 2% of its average thickness along its width.

31. A pre-impregnated material according to claim 24 and wherein said resin has an impregnation depth of at least 80% of the thickness of said textile substrate.

32. A pre-impregnated material comprising:
a textile substrate; and
resin adhered to said textile substrate,
said pre-impregnated material being characterized in that the weight of said resin is less than 10% of the weight of said pre-impregnated material.

33. A pre-impregnated material according to claim 32 and wherein the weight of said resin is less than 5% of the weight of said pre-impregnated material.

34. A pre-impregnated material according to claim 32 and wherein said resin has a uniformity of thickness having a variation of less than 2% of its average thickness.

35. A pre-impregnated material according to claim 32 and wherein said resin has a uniformity of thickness having a variation of less than 2% of its average thickness along its width.

36. A pre-impregnated material according to claim 32 and wherein said resin has an impregnation depth of at least 60% of the thickness of said textile substrate.

37. A pre-impregnated material according to claim 36 and wherein said resin has a uniformity of thickness having a variation of less than 5% of its average thickness.

38. A pre-impregnated material according to claim 32 and wherein said resin has an impregnation depth of at least 80% of the thickness of said textile substrate.

39. A pre-impregnated material comprising:
a textile substrate; and
resin adhered to said textile substrate,
said pre-impregnated material being characterized in that said resin includes particles having a size spectrum which extends over at least two orders of magnitude.

40. A pre-impregnated material according to claim 39 and wherein said resin has a uniformity of thickness having a variation of less than 2% of its average thickness.

41. A pre-impregnated material according to claim 40 and wherein said resin has a uniformity of thickness having a variation of less than 2% of its average thickness along its width.

42. A pre-impregnated material according to claim 39 and wherein said resin has an impregnation depth of at least 60% of the thickness of said textile substrate.

43. A pre-impregnated material according to claim 42 and wherein said resin has a uniformity of thickness having a variation of less than 5% of its average thickness.

44. A pre-impregnated material according to claim 42 and wherein said resin has a uniformity of thickness having a variation less than 2% of its average thickness.

45. A pre-impregnated material according to claim 42 and wherein said resin has a uniformity of thickness having a variation less than 2% of its average thickness along its width.

46. A pre-impregnated material according to claim 39 and wherein said resin has an impregnation depth of at least 80% of the thickness of said textile substrate.

47. A pre-impregnated material comprising:
a textile substrate; and
resin adhered to said textile substrate,
said pre-impregnated material being characterized in that said resin includes particles having a density spectrum which extends over at least one order of magnitude.

48. A pre-impregnated material according to claim 47 and wherein said resin has a uniformity of thickness having a variation of less than 2% of its average thickness.

49. A pre-impregnated material according to claim 47 and wherein said resin has a uniformity of thickness having a variation of less than 2% of its average thickness along its width.

50. A pre-impregnated material according to claim 47 and wherein said resin has an impregnation depth of at least 60% of the thickness of said textile substrate.

51. A pre-impregnated material according to claim 50 and wherein said resin has a uniformity of thickness having a variation of less than 5% of its average thickness.

52. A pre-impregnated material according to claim 51 and wherein said resin has a uniformity of thickness having a variation less than 2% of its average thickness.

53. A pre-impregnated material according to claim 50 and wherein said resin has a uniformity of thickness having a variation less than 2% of its average thickness along its width.

54. A pre-impregnated material according to claim 47 and wherein said resin has an impregnation depth of at least 80% of the thickness of said textile substrate.

55. A pre-impregnated material according to claim 1 and wherein said resin is fully melted.

56. A pre-impregnated material according to claim 1 and wherein said resin is partially melted and partially in particulate form.

57. A pre-impregnated material according to claim 1 and wherein said resin is formed as a plurality of resin layers.

58. A pre-impregnated material according to claim 1 and wherein said resin is formed as a plurality of resin layers having different thicknesses.

59. A pre-impregnated material according to claim 1 and wherein said resin is formed as a plurality of resin layers formed of different resin materials.

60. A pre-impregnated material according to claim 9 and wherein said resin is fully melted.

61. A pre-impregnated material according to claim 9 and wherein said resin is partially melted and partially in particulate form.

62. A pre-impregnated material according to claim 9 and wherein said resin is formed as a plurality of resin layers.

63. A pre-impregnated material according to claim 9 and wherein said resin is formed as a plurality of resin layers having different thicknesses.

64. A pre-impregnated material according to claim 9 and wherein said resin is formed as a plurality of resin layers formed of different resin materials.

65. A pre-impregnated material according to claim 16 and wherein said resin is fully melted.

66. A pre-impregnated material according to claim 16 and wherein said resin is partially melted and partially in particulate form.

67. A pre-impregnated material according to claim 16 and wherein said resin is formed as a plurality of resin layers.

68. A pre-impregnated material according to claim 16 and wherein said resin is formed as a plurality of resin layers having different thicknesses.

69. A pre-impregnated material according to claim 16 and wherein said resin is formed as a plurality of resin layers formed of different resin materials.

70. A pre-impregnated material according to claim 24 and wherein said resin is fully melted.

71. A pre-impregnated material according to claim 24 and wherein said resin is partially melted and partially in particulate form.

72. A pre-impregnated material according to claim 24 and wherein said resin is formed as a plurality of resin layers.

73. A pre-impregnated material according to claim 24 and wherein said resin is formed as a plurality of resin layers having different thicknesses.

74. A pre-impregnated material according to claim 24 and wherein said resin is formed as a plurality of resin layers formed of different resin materials.

75. A pre-impregnated material according to claim 32 and wherein said resin is fully melted.

76. A pre-impregnated material according to claim 32 and wherein said resin is partially melted and partially in particulate form.

77. A pre-impregnated material according to claim 32 and wherein said resin is formed as a plurality of resin layers.

78. A pre-impregnated material according to claim 32 and wherein said resin is formed as a plurality of resin layers having different thicknesses.

79. A pre-impregnated material according to claim 32 and wherein said resin is formed as a plurality of resin layers formed of different resin materials.

80. A pre-impregnated material according to claim 39 and wherein said resin is fully melted.

81. A pre-impregnated material according to claim 39 and wherein said resin is partially melted and partially in particulate form.

82. A pre-impregnated material according to claim 39 and wherein said resin is formed as a plurality of resin layers.

83. A pre-impregnated material according to claim 39 and wherein said resin is formed as a plurality of resin layers having different thicknesses.

84. A pre-impregnated material according to claim 39 and wherein said resin is formed as a plurality of resin layers formed of different resin materials.

85. A laminate formed of a plurality of layers of pre-impregnated material, at least one of said plurality of layers of pre-impregnated material comprising:
a textile substrate; and
resin adhered to said textile substrate,
said pre-impregnated material being characterized in that said resin has a uniformity of thickness having a variation of less than 5% of its average thickness.

86. A laminate formed of a plurality of layers of pre-impregnated material, at least one of said plurality of layers of pre-impregnated material comprising:
a textile substrate; and
resin adhered to said textile substrate,
said pre-impregnated material being characterized in that said resin has a thickness exceeding 300 microns.

87. A laminate formed of a plurality of layers of pre-impregnated material, at least one of said plurality of layers of pre-impregnated material comprising:
a textile substrate; and
resin adhered to said textile substrate,
said pre-impregnated material being characterized in that the weight of said resin is at least 70% of the weight of said pre-impregnated material.

88. A laminate formed of a plurality of layers of pre-impregnated material, at least one of said plurality of layers of pre-impregnated material comprising:
a textile substrate; and
resin adhered to said textile substrate,
said pre-impregnated material being characterized in that said resin has a thickness less than 50 microns.

89. A laminate formed of a plurality of layers of pre-impregnated material, at least one of said plurality of layers of pre-impregnated material comprising:
a textile substrate; and
resin adhered to said textile substrate,
said pre-impregnated material being characterized in that the weight of said resin is less than 10% of the weight of said pre-impregnated material.

90. A laminate formed of a plurality of layers of pre-impregnated material, at least one of said plurality of layers of pre-impregnated material comprising:
a textile substrate; and
resin adhered to said textile substrate,
said pre-impregnated material being characterized in that said resin includes particles having a size spectrum which extends over at least two orders of magnitude.

91. A laminate formed of a plurality of layers of pre-impregnated material, at least one of said plurality of layers of pre-impregnated material comprising:
a textile substrate; and
resin adhered to said textile substrate,
said pre-impregnated material being characterized in that said resin includes particles having a density spectrum which extends over at least one order of magnitude.
